(19) United States
(12) Patent Application Publication
(10) Pub. No.: US 2023/0154356 A1
(43) Pub. Date: May 18, 2023

(54) HEMORRHAGE CONTROL TRAINING DEVICE, METHOD, AND SYSTEM

(71) Applicant: Rhys Joseph Williams, Greenback, TN (US)

(72) Inventor: Rhys Joseph Williams, Greenback, TN (US)

(21) Appl. No.: 18/046,288

(22) Filed: Oct. 13, 2022

Related U.S. Application Data
(60) Provisional application No. 63/250,774, filed on Sep. 30, 2021.

(51) Int. Cl. G09B 23/30

(52) U.S. Cl. CPC G09B 23/303

(57) ABSTRACT

A table and pump system that allows for distribution, collection, filtration, warming and recirculation of simulated blood for the purposes of conducting medical training, wherein the hemorrhage control training device, method and system of the present invention allows for the utilization of a full body sized hemorrhage control task trainer to be used with multiple simulated bleeding sites a various and selectable flow types and pressure, wherein the systems automatically collects the expelled simulated blood, filtrates it, and warm the simulated blood up for continual effect or a future training regime.

### CROSS-REFERENCE TO RELATED APPLICATION

This application claims the benefit of priority of U.S. Provisional Application No. 63/250,774, filed 30-SEP-2021, the contents of which are herein incorporated by reference.

### BACKGROUND OF THE INVENTION

The present invention relates to hemorrhage control training systems and, more particularly, a table and pump system that allows for distribution, collection, filtration, warming and recirculation of simulated blood for the purposes of conducting medical training.

Where high-fidelity simulators are invaluable in practicing a patient encounter, task trainers allow for the refining of psychomotor skills in isolation. Task trainers allow learners to familiarize themselves with various procedures that require repetitive practice in a safe environment before the trainee are expected to perform the procedure on a real patient.

Task trainers related to hemorrhage control training require large amounts of simulated blood. Moreover, currently no hemorrhage control training system allows for adjustment of flow, filtration, warming and recirculation of simulated blood. No Hemorrhage control training system allows for selective adjustment by the end user for changing the location, position, flow, and pressure of hemorrhage control task trainers. In other words, current hemorrhage control training systems do not enable the end user to modify the system for their own, bespoke use of creating custom training situations. Furthermore, there is no current hemorrhage control training system that allows a full body sized hemorrhage control task trainer to distribute collectable simulated blood for recirculation during a single training session as well as for repeated use.

As can be seen, there is a need for a table and pump system that allows for distribution, collection, filtration, warming and recirculation of simulated blood for the purposes of conducting medical training, wherein the hemorrhage control training device, method and system of the present invention allows for the utilization of a full body sized hemorrhage control task trainer to be used with multiple simulated bleeding sites a various and selectable flow types and pressure, wherein the systems automatically collects the expelled simulated blood, filtrates it, and warm the simulated blood up for continual effect or a future training regime. By collecting, filtering, warming and recirculating simulated blood, training of large numbers of students in lifesaving procedures can be accomplished quickly and at reduced cost.

### SUMMARY OF THE INVENTION

In one aspect of the present invention, a hemorrhage control training device, includes the following: a surface dimensioned to accommodate at least one hemorrhage control task trainer; and a fluid container fluidly coupled to the surface by way of a pumping system providing one or more pumps; a pump controller; and one or more outlets disposed along the hemorrhage control task trainer, wherein the pump controller is configured to change a flow type and a pressure of a fluid in the pumping system.

In another aspect of the present invention, the hemorrhage control training device further includes wherein the fluid is simulated blood, wherein the one or more outlets comprise at least two outlets, wherein the pumping system further comprises a distribution manifold for selectively distributing two or more flows of the fluid, wherein the at least one hemorrhage control task trainer comprises an adult human-sized hemorrhage control task trainer; further including a fluid retention system operatively associated with the surface so that the two or more flows of the fluid flows back to the fluid container, wherein the surface is an upper portion of a table; and further including a fluid temperature regulator configured to selectively control a temperature of the fluid, and wherein the flow type comprises continuous and intermittent.

In yet another aspect of the present invention, a hemorrhage control training system includes the following: a table having an upper surface dimensioned to accommodate at least one hemorrhage control task trainer; a simulated blood container fluidly coupled to the surface by way of a pumping system providing: one or more pumps; a pump controller; a distribution manifold for selectively distributing two or more flows of the simulated blood; and a plurality of outlets disposed along the hemorrhage control task trainer, wherein the pump controller is configured to change a flow type and a pressure of the simulated blood in the pumping system; a fluid retention system operatively associated with the surface so that the two or more flows of the simulated blood flow back to the simulated blood container; and a simulated blood temperature regulator configured to selectively control a temperature of the simulated blood, wherein the flow type comprises continuous and intermittent. The intermittent flow may be pulse-based, such that the simulated blood is urged through pulses that have a magnitude substantially greater than the non-pulse urgings so as to mimic the blood pumping of a human or animal heart. Between pulses the related simulated blood pressure may be substantially less than the pulse pressure.

In still yet another aspect of the present invention, the A method of training hemorrhage control, the method includes: providing the above-mentioned hemorrhage control training system; placing a human-sized hemorrhage control task trainer on the surface thereof; and selectively controlling the pumping system to simulate two or more bleed sites along the human-sized hemorrhage control task trainer as well as selectively controlling the simulated blood temperature regulator so that simulated blood leaving each bleed site is approximately the temperature of human blood.

These and other features, aspects and advantages of the present invention will become better understood with reference to the following drawings, description and claims.

### BRIEF DESCRIPTION OF THE DRAWINGS

FIG. 1 is a top perspective view of an exemplary embodiment of the present invention.

FIG. 2 is a side schematic view of an exemplary embodiment of the present invention, shown in use with tube 26 connected to trainer 30.

FIG. 3 is a flow chart of an exemplary embodiment of the present invention.

FIG. 4 is a top perspective view of an exemplary embodiment of the present invention.

FIG. 5 is a side schematic view of an exemplary embodiment of the present invention.

FIG. 6 is a top perspective view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, an embodiment of the present invention provides a table and pump system that allows for distribution, collection, filtration, warming and recirculation of simulated blood for the purposes of conducting medical training, wherein the hemorrhage control training device, method and system of the present invention allows for the utilization of a full body sized hemorrhage control task trainer to be used with multiple simulated bleeding sites a various and selectable flow types and pressure, wherein the systems automatically collects the expelled simulated blood, filtrates it, and warm the simulated blood up for continual effect or a future training regime.

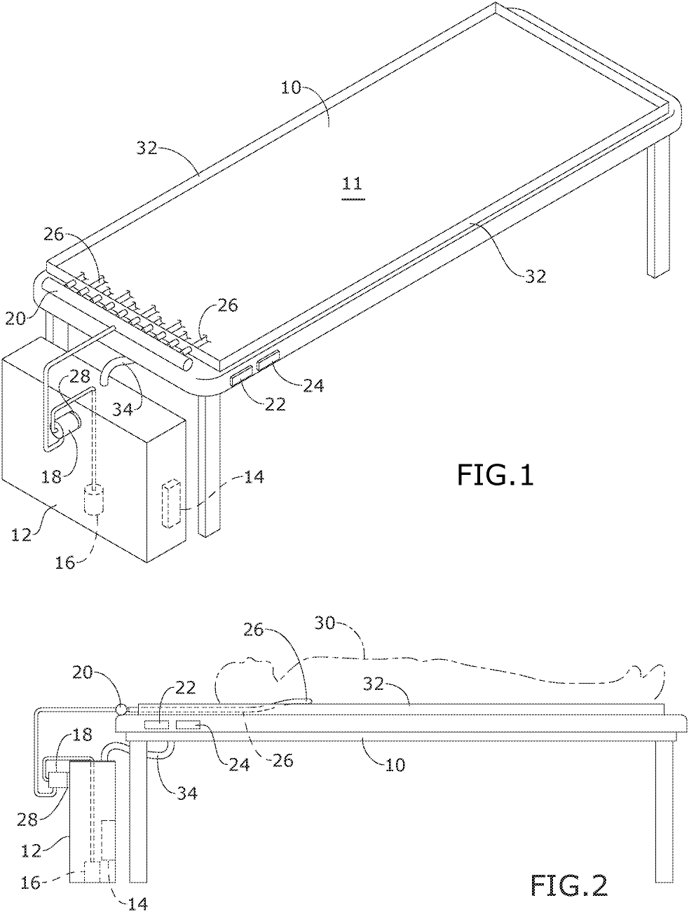

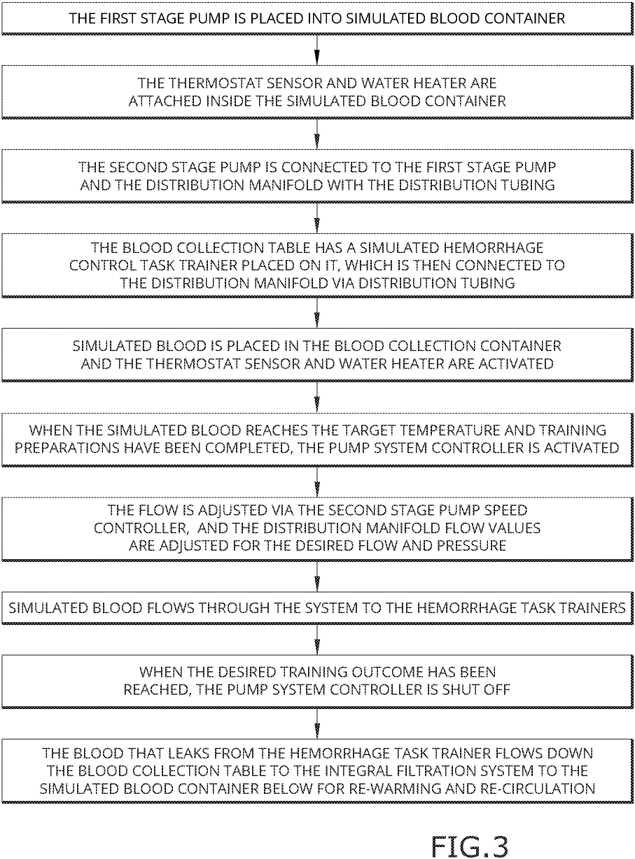

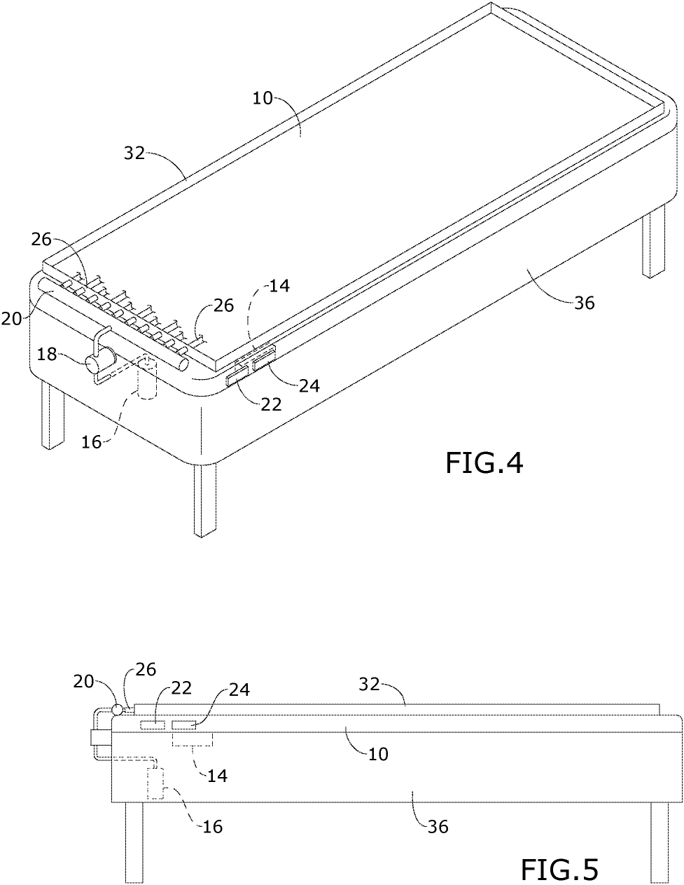

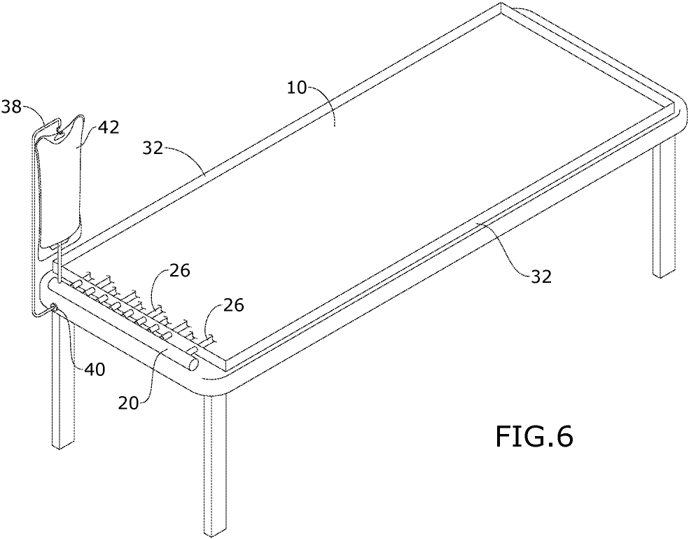

Referring now to FIGS. 1 through 6, the present invention may include a blood collection table 10. The blood collection table 10 is fluidly coupled to one or more simulated blood containers 12. Each simulated blood container 12 is fluidly coupled to a thermostat and water heater 14 so that the latter can selectively regulate the temperature of the simulated blood contained by the simulated blood container 12, while the former determines the temperature thereof. One or more pumps, such as a first stage pump 16 and a second stage pump 18, may be fluidly coupled to each simulated blood container 12 for selectively urging the contained simulated blood to and from its simulated blood container 12.

The one or more pumps (16, 18, etc.) may be fluidly coupled to a distribution manifold 20 dimensioned and adapted to selective branch the flow of simulated blood into a plurality of openings, each opening fluidly coupled to a conduit 26 for distribution along different points along and/or adjacent to the upper surface 11 of the blood collection table 10 and/or through a hemorrhage control task trainer 30. The one or more pumps 16 and/or 18 may be external to the simulated blood container 12. In certain embodiments, such pump(s) 16 and/or 18 may be attached to the simulated blood container 12 at attachment points 28, wherein the attachment point is a magnet or other form of removably joining element for connecting one object to another object. In some embodiments, the first stage pump 16 is located inside the simulated blood container 12, while the second stage pump 18 is located along the exterior of the simulated blood container 12 by the attachment point 28.

The one or more pumps 16 and 18, distribution manifolds 10, and/or distribution conduits 26 may be operatively associated with a pump speed controller 22 and/or a pump system controller 24 so that a user may selectively control and regulate the end-to-end distribution of simulated blood therethrough and the overall hemorrhage control training system’s throughput.

The upper surface 11 of the blood collection table 10 may be operatively associated with a fluid retention system 32 to prevent blood for leaking out of the hemorrhage control training system. The fluid retention system 32 may include water-resistant rails or barriers circumscribing said upper surface 11. The upper surface 11 is dimensioned and adapted to accommodate one or more human-sized (or in certain embodiments, animal sized) hemorrhage control task trainers 30, which may be akin to a mannequin adapted to pedagogically replicate a human victim experiencing ‘life-threatening’ blood hemorrhaging.

In certain embodiments, the first stage pump 16 may be placed in the simulated blood container 12, and the thermostat sensor and water heater 14 may be attached inside the simulated blood container 12 using magnetic attachment points 28. The second stage pump 16 may be connected to the first stage pump 16 and the distribution manifold 20 with the distribution tubing 26.

During operation, the blood collection table 10 may have a simulated hemorrhage control task trainer 30 placed on it that is connected to the distribution manifold 20 via the distribution tubing 26. Simulated blood may be placed in the blood collection container 12 and the thermostat sensor and water heater 14 is activated. When the simulated blood reaches the selected target temperature and training preparations have been completed, the pump system controller 24 may be activated, and the flow is adjusted via the second stage pump speed controller 22 and distribution manifold 20 flow values to selectively adjust the desired flow type (e.g., continuous, intermittent, etc.) and pressure. Simulated blood then flows through the system to the hemorrhage task trainer(s) 30. When the desired training outcome has been reached, the pump system controller 24 may be shut off. The blood that leaks from the hemorrhage task trainers 30 flows down the blood collection table 10, corralled by the fluid retention system 32, to an integral filtration system 34 and then back to the simulated blood container 12 for rewarming and recirculation.

In another embodiment, the blood collection table 10 may embody a cistern 36 for storing simulated blood within its body as opposed to a separately associated simulated blood container 12. In other embodiments, the blood collection table 10 may include a bag hanger 38 for a gravitational-fed distribution bag 42 above the upper surface 11. The bag hanger 38 may be removably connected to the blood collection table 10 by way of a removably attachment point 40, for instance a magnetizable material.

The blood collection table 10 may be rectangular and constructed of steel or aluminum that may be welded with six handles around the exterior, two wheels to one end, and a drainage spout with mesh filter. It being understood various forms of construction material and number of constituent components may vary. In certain embodiments, a drainage spout may be connected to a flexible conduit that leads to the simulated blood container 12. Folding legs for the blood collection table 10 may be constructed via welding out of steel or aluminum. The distribution manifold 20 may be bolted to the blood collection table 10.

The simulated blood container 12 may be rectangular or round container is constructed of steel and painted with enamel with a waterproof locking lid. Attached to the top and bottom of the container may be an elastic strap for firm connection to the legs of the blood collection table 10.

The thermostat and water heater 14 may be a commercially available thermostat for the purpose, for example, of keeping farm animals water source free from ice. The first stage pump 16 may be commercially available fountain pump modified by connecting the blood distribution tubing 26 and the second stage pump 18. The second stage pump 18 may be a commercially available rotary pump modified for connecting the blood distribution tubing 26 and the distribution manifold 20. The distribution manifold 20 may be created via drilling pipe and threading tube connectors with vales to create the desired amount of distribution outlets. The second stage pump speed controller 22 may be a commercially available DC volt adjuster that is manually wired to the second stage pump 18. The pump system controller 24 may be a wireless or wired switch that activates the pump system, and so be manually wired to the pump system and a power source. The distribution tubing 26 may be created by cutting the desired PVC tubing to length and connecting quick disconnect connectors and one way check valves. The magnetic attachment points 28 may include earth magnets attached to webbing and quick disconnect clips via sewing to create straps.

The water heater and thermostat 14 may be optional, though it creates the realistic feel of warm blood through the system to the hemorrhage control task trainer 30. The pumps 16 and 18 could be arranged in various configurations or be adjusted to pump laterally or downward to allow work to be performed at variable positions.

A method of using the present invention may include the following. The blood collection table 10 disclosed above may be provided. An end-user would apply one or more hemorrhage control task trainers 30 to a full-sized human or animal medical training model. Tubing to each task trainer 30 would be connected to the distribution manifold 20 via connection tubing 26 in the selectively specified order of use. After adding simulated blood to the container 12, the thermostat 14 is activated to warm the simulated blood and the pumps 16 and 18 may be activated to start the flow of simulated blood. The flow and pressure may be adjusted via the outlet valves on the distribution manifold 20 and the second stage power speed controller 24.

Additionally, the table 10 could be used to circulate cleaning solutions for the purpose of cleaning machine parts as well as product testing and research.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the invention and that modifications may be made without departing from the spirit and scope of the invention as set forth in the following claims.

What is claimed is:

1. A hemorrhage control training device, comprising:
a surface dimensioned to accommodate at least one hemorrhage control task trainer; and
a fluid container fluidly coupled to the surface by way of a pumping system comprising:
one or more pumps;
a pump controller; and
one or more outlets disposed along the hemorrhage control task trainer, wherein the pump controller is configured to change a flow type and a pressure of a fluid in the pumping system.

2. The hemorrhage control training device of claim 1, wherein the fluid is simulated blood.

3. The hemorrhage control training device of claim 1, wherein the one or more outlets comprise at least two outlets.

4. The hemorrhage control training device of claim 3, wherein the pumping system further comprises a distribution manifold for selectively distributing two or more flows of the fluid.

5. The hemorrhage control training device of claim 4, wherein the at least one hemorrhage control task trainer comprises an adult human-sized hemorrhage control task trainer.

6. The hemorrhage control training device of claim 3, further comprising a fluid retention system operatively associated with the surface so that the two or more flows of the fluid flows back to the fluid container.

7. The hemorrhage control training device of claim 6, wherein the surface is an upper portion of a table.

8. The hemorrhage control training device of claim 2, further comprising a fluid temperature regulator configured to selectively control a temperature of the fluid.

9. The hemorrhage control training device of claim 8, wherein the flow type comprises continuous and intermittent.

10. A hemorrhage control training system, comprising:
a table having an upper surface dimensioned to accommodate at least one hemorrhage control task trainer;
a simulated blood container fluidly coupled to the surface by way of a pumping system comprising:
one or more pumps;
a pump controller;
a distribution manifold for selectively distributing two or more flows of the simulated blood; and
a plurality of outlets disposed along the hemorrhage control task trainer, wherein the pump controller is configured to change a flow type and a pressure of the simulated blood in the pumping system;
a fluid retention system operatively associated with the surface so that the two or more flows of the simulated blood flow back to the simulated blood container; and
a simulated blood temperature regulator configured to selectively control a temperature of the simulated blood.

11. The hemorrhage control training device of claim 10, wherein the flow type comprises continuous and intermittent.

12. A method of training hemorrhage control, the method comprising:
providing the hemorrhage control training system of claim 10;
placing a human-sized hemorrhage control task trainer on the surface thereof; and
selectively controlling the pumping system to simulate two or more bleed sites along the human-sized hemorrhage control task trainer.

13. The method of claim 12, further comprising selectively controlling the simulated blood temperature regulator so that simulated blood leaving each bleed site is approximately the temperature of human blood.
